(19) United States
(12) Patent Application Publication
(10) Pub. No.: US 2016/0078812 A1
(43) Pub. Date: Mar. 17, 2016

(54) ORGANIC LIGHT EMITTING DISPLAY DEVICE

(71) Applicant: Samsung Display Co., Ltd., Yongin-city (KR)

(72) Inventors: Jae-Sic LEE, Yongin-City (KR); Mi-Hae KIM, Yongin-city (KR)

(21) Appl. No.: 14/752,246

(22) Filed: Jun. 26, 2015

(30) Foreign Application Priority Data
Sep. 16, 2014 (KR) 10-2014-0122727

(51) Int. Cl. G09G 3/32

(52) U.S. Cl. CPC G09G 3/3233; G09G 3/3266; G09G 3/3275; G09G 2330/08; G09G 2300/0819; G09G 2310/0248

(57) ABSTRACT

An organic light emitting display device includes: a data line and an auxiliary data line; a scan line disposed crossing the a data line and the auxiliary data line; a display pixel disposed where the data line and the scan line cross; an auxiliary pixel disposed where the auxiliary data line, and the scan line cross; and an auxiliary line connected to the auxiliary pixel, wherein the auxiliary pixel includes: a discharge transistor coupled to the auxiliary line and a first power voltage line to which a first power voltage is supplied; and a discharge transistor controller configured to switch the discharge transistor.

### CROSS-REFERENCE TO RELATED APPLICATION

This application claims priority from and the benefit of Korean Patent Application No. 10-2014-0122727, filed on Sep. 16, 2014, which is hereby incorporated by reference for all purposes as if fully set forth herein.

### BACKGROUND

1. Field

The present invention relates to an organic light emitting display device.

2. Discussion of the Background

As an information-oriented society has been developed, demand for a display device for displaying an image has increased in various forms, and various flat panel display devices such as a liquid crystal display device, a plasma display panel, and an organic light emitting display device have recently been utilized.

The organic light emitting display device among the flat panel display devices includes a display panel including data lines, scan lines, and a plurality of pixels disposed in a matrix form in crossing regions of the data lines and the scan lines, a data driver for supplying data voltages to the data lines, and a scan driver for supplying scan signals to scan lines. Further, the display panel further includes a power supply unit for supplying a plurality of power voltages. Each of the pixels emits light with predetermined brightness by controlling a current flowing from a first power voltage among the plurality of power voltages to an organic light emitting diode according to a data voltage supplied through the data line when a scan signal is supplied by using a plurality of transistors.

However, a defect may be generated in the transistors of the pixels while manufacturing the organic light emitting display device, deteriorating a quality of the organic light emitting display device. In order to solve the problem, a method of repairing the defective pixel by forming auxiliary pixels in an organic light emitting display device and connecting the defective pixel to one of the auxiliary pixels had been suggested.

According to the conventional repair method, when the transistors of the defective pixel and the organic light emitting diode are disconnected due to defect, the transistors of the auxiliary pixel may be connected to an anode electrode of the organic light emitting diode of the defective pixel via an auxiliary line. As a result, it is possible to make the organic light emitting diode of the defective pixel emit light by driving the transistors of the auxiliary pixel.

However, parasitic capacitances may be formed between the auxiliary line and the anode electrodes of the organic light emitting diodes of the pixels other than the repaired pixel, and fringe capacitances may be formed between the auxiliary line and an adjacent scan line. In this case, the parasitic capacitance and the fringe capacitance may affect the auxiliary line voltage, and an organic light emitting diode of the repaired pixel may erroneously emit light.

The above information disclosed in this Background section is only for enhancement of understanding of the background of the invention and therefore it may contain information that does not form any part of the prior art nor what the prior art may suggest to a person of ordinary skill in the art.

### SUMMARY

Exemplary embodiments of the present invention provides an organic light emitting display device capable of preventing or limiting an organic light emitting diode of a repaired pixel from erroneously emitting light.

Additional features of the invention will be set forth in the description which follows, and in part will be apparent from the description, or may be learned by practice of the invention.

An exemplary embodiment provides an organic light emitting display device, including: a data line and an auxiliary data line; a scan line disposed crossing the data line and the auxiliary data line; a display pixel disposed where the data line and the scan line cross; an auxiliary pixel disposed where the auxiliary data line and the scan line cross; and an auxiliary line connected to the auxiliary pixel, wherein the auxiliary pixel includes: a discharge transistor coupled to the auxiliary line and a first power voltage line to which a first power voltage is supplied; and a discharge transistor controller configured to switch the discharge transistor.

An exemplary embodiment also provides a method of driving a flat panel display, including: determining existence of a repaired pixel; preparing auxiliary data to feed the repaired pixel when the repaired pixel exists; storing the auxiliary data; generating a signal based on the auxiliary data; and feeding the signal to the repaired pixel.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a block diagram illustrating an organic light emitting display device according to an exemplary embodiment.

FIG. 2 is a block diagram illustrating display pixels, auxiliary pixels, auxiliary lines, auxiliary data lines, and a second data driver of FIG. 1 in detail.

FIG. 3 is a flow chart illustrating a driving method of the second data driver of FIG. 2.

FIGS. 4A and 4B are diagrams illustrating an example of data voltages output from a first data driver of FIG. 2, and auxiliary data voltages output from an auxiliary data voltage converter of the second data driver.

FIG. 5 is a circuit diagram illustrating exemplary display pixels and an auxiliary pixel of a display panel according to an exemplary embodiment.

FIG. 6 is a circuit diagram illustrating an example of a k+2^{th} stage of a scan driver for outputting a k+2^{th} scan signal of FIG. 5.

FIG. 7 is a waveform illustrating signals supplied to the display pixels and the auxiliary pixel of FIG. 5.

FIG. 8 is a circuit diagram illustrating display pixels and auxiliary pixels of a display panel according to an exemplary embodiment.

FIG. 9 is a waveform illustrating signals supplied to the display pixels and the auxiliary pixel of FIG. 8.

### DETAILED DESCRIPTION OF THE ILLUSTRATED EMBODIMENTS

Hereinafter, exemplary embodiments of the present invention will be described in detail with reference to the accompanying drawings. Like reference numerals principally refer to like elements throughout the specification. In the following description, when the detailed description of the relevant known function or configuration is determined to unnecessarily obscure the important point of the present invention, the detailed description is not provided. Further, a name of a constituent elements used in description below may be selected in consideration of easiness of writing the specification, and thus may be different from a name of a component of an actual product.

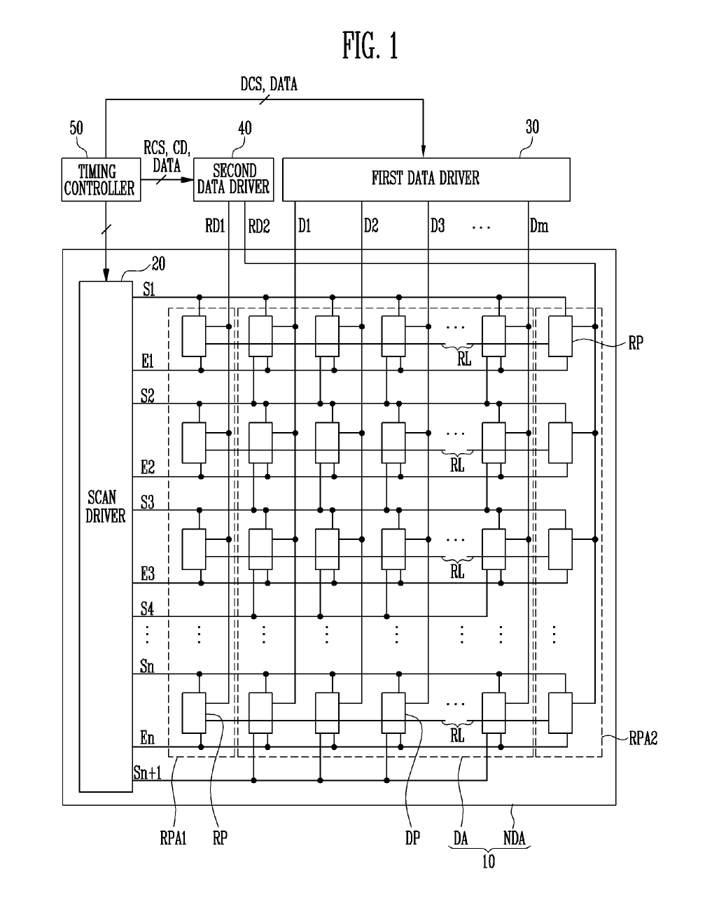

FIG. 1 is a block diagram illustrating an organic light emitting display device according to an exemplary embodiment. Referring to FIG. 1, an organic light emitting display device according to an exemplary embodiment includes a display panel 10, a scan driver 20, a first data driver 30, a second data driver 40, and a timing controller 50.

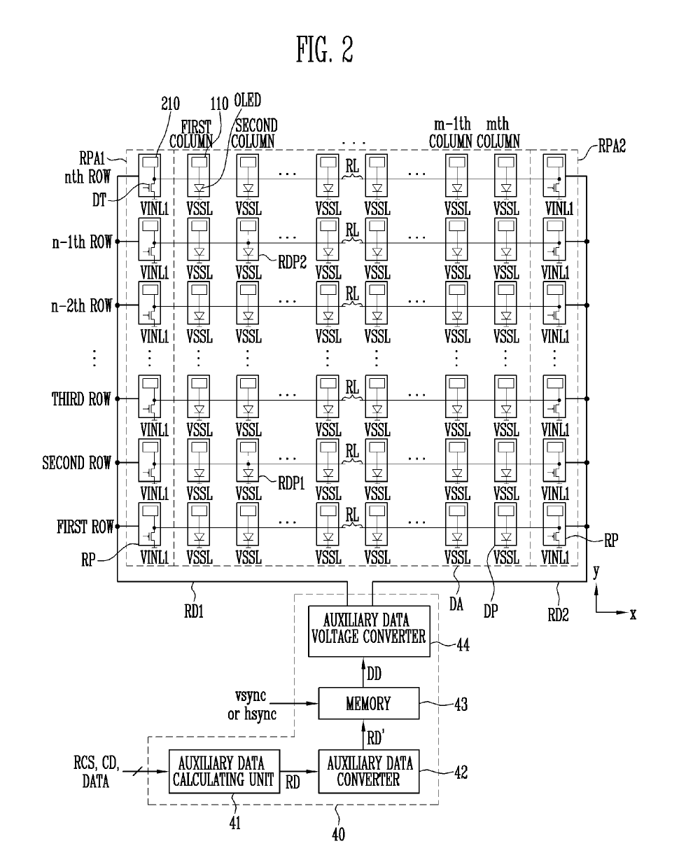

The display panel may include data lines D1 to Dm (m is a positive integer equal to or greater than 2), auxiliary data lines RD1 and RD2, scan lines S1 to Sn+1 (n is a positive integer equal to or greater than 2), and emission control lines E1 to En. The data lines D1 to Dm and the auxiliary data lines RD1 and RD2 may be formed in parallel to each other. The auxiliary data lines RD1 and RD2 may be formed at outsides of two opposing sides of the data lines D1 to Dm. For example, as illustrated in FIG. 2, the first auxiliary data line RD1 may be formed at an outer side of one side of the data lines D1 to Dm, and the second auxiliary data line RD2 may be formed at an outer side of the opposing side of the data lines D1 to Dm. The scan lines S1 to Sn+1 may be formed to intersect the data lines D1 to Dm. The scan lines S1 to Sn may also be formed to intersect the auxiliary data lines RD1 and RD2. The scan lines S1 to Sn and the emission control lines E1 to En may be formed in parallel to each other.

The display panel 10 includes a display area DA, in which display pixels DPs for displaying an image are formed, and a non-display area NDA corresponding to an area of the display panel 10 other than the display area DA. The non-display area NDA may include first and second auxiliary pixel areas RPA1 and RPA2, in which auxiliary pixels RPs that repairs the display pixels DPs are formed. The auxiliary pixels RPs connected to a first auxiliary data line RD1 may be formed in a first auxiliary pixel area RPA1, and the auxiliary pixels RPs connected to a second auxiliary data line RD2 may be formed in a second auxiliary pixel area RPA2.

The display pixels DPs may be disposed in a matrix form in crossing areas where the data lines D1 to Dm and the scan lines S1 to Sn+1 intersect in the display area DA. Each of the display pixels DPs may be connected to one data line, two scan lines, and one emission control line.

The auxiliary pixels RPs may be disposed in the crossing areas where the auxiliary data lines RD1 and RD2 and the scan lines S1 to Sn+1 intersect respectively in the first and second auxiliary pixel areas RPA1 and RPA2. The auxiliary pixels RPs are pixels for repairing the display pixels DPs, when the display panel 10 got a defect while manufacturing the display panel 10. Each of the auxiliary pixels RPs may be connected to one auxiliary data line, two scan lines, one emission control line, and one auxiliary line RL. The auxiliary line RL is extended from the auxiliary pixels RPs in the first and second auxiliary pixel areas RPA1 and RPA2 into the display area DA, and overlapping the display pixels DPs in the display area DP.

When a defect is generated in the display pixel DP, the defective display pixel DP may be connected to the auxiliary line RL through a laser short-circuit process. Accordingly, the auxiliary pixel RP may be connected to the defective display pixel DP through the auxiliary line RL to repair the defective display pixel DP by using the auxiliary pixel RP. Hereinafter, for convenience of the description, the defective display pixel DP that had been repaired may be referred to as a repaired pixel.

The display pixels DPs and the auxiliary pixels RPs of the display panel 10 according to the exemplary embodiment of the present invention will be described below in detail with reference to FIG. 1.

Further, a plurality of power voltage lines (not illustrated) for supplying a plurality of power voltages to the display pixels DPs and the auxiliary pixels RPs may be formed in the display panel 10. However, the plurality of power voltage lines is not illustrated in FIG. 1 for convenience of the description.

The scan driver 20 may include a scan signal output unit for outputting scan signals to the scan lines S1 to Sn+1, and an emission control signal output unit for outputting emission control signals to the emission control line E1 to En. The scan signal output unit receives a scan timing control signal SCS from the timing controller 50, and outputs the scan signals to the scan lines S1 to Sn+1 according to the scan timing control signal SCS. The emission control signal output unit receives an emission timing control signal ECS from the timing controller 50, and outputs the emission control signals to the emission control lines E1 to En according to the emission timing control signal ECS.

The scan signal output unit and the emission control signal output unit may be disposed in the non-display area NDA of the display panel 10 in an Amorphous Silicon Gate in Pixel (AGS) scheme or a Gate Driver in Panel (GIP) scheme. In such case, each of the scan signal output unit and the emission control signal output unit may include subordinately connected scan stages thereto. The scan stages may sequentially output the scan signals to the scan lines S1 to Sn+1, and emission stages may sequentially output the emission control signals to the emission control lines E1 to En.

The first data driver 30 includes at least one source drive Integrated Circuit (IC). The source drive IC receives a digital video data DATA and a data timing control signal DCS from the timing controller 50. The source drive IC converts the digital video data DATA to data voltages in response to a data timing control signal DCS. The source drive IC synchronizes each of the scan signals to one of the data voltages, respectively, and supplies the synchronized data voltages to the data lines D1 to Dm. Accordingly, the data voltages may be supplied to the display pixels DPs, to which the corresponding scan signal is supplied.

The second data driver 40 receives a repair control signal RCS, the digital video data DATA, and coordinate data CD of the repaired pixel from the timing controller 50. The second data driver 40 generates auxiliary data voltages by using the repair control signal RCS, the digital video data DATA, and the coordinate data CD of the repaired pixel. The second data driver 40 synchronizes each of the auxiliary data voltages to one of the scan signals, respectively, and supplies the synchronized auxiliary data voltages to the auxiliary data lines RD1 and RD2. Accordingly, the auxiliary data voltages may be supplied to the auxiliary pixels RPs, to which the corresponding scan signal is supplied. Particularly, the second data driver 40 supplies the same auxiliary data voltage as the data voltage, which is to be supplied to the repaired pixel, to the auxiliary pixel connected to the repaired pixel in order to repair the repaired pixel. The second data driver 40 will be described in detail with reference to FIGS. 2 to 4.

The timing controller 50 receives the digital video data DATA and timing signals (not illustrated) from the external device. The timing signals (not illustrated) may include a vertical sync signal, a horizontal sync signal, a data enable signal, a dot clock, and the like. The timing controller 50 is configured to generate timing control signals for controlling the scan driver 20 and the first data driver 30 based on the timing signals. The timing control signals include the scan timing control signal SCS for controlling an operation timing of the scan signal output unit of the scan driver 20, the emission timing control signal ECS for controlling an operation timing of the emission control signal output unit of the scan driver 20, and the data timing control signal DCS for controlling an operation timing of the first data driver 30. The timing controller 50 is configured to output the scan timing control signal SCS and the emission timing control signal ECS to the scan driver 20, and outputs the data timing control signal DCS and the digital video data DATA to the first data driver 30. Further, the timing controller 50 is configured to generate the repair control signal RCS and the coordinate data CD of the repaired pixel. The repaired control signal RCS is a signal indicating whether the repaired pixel exists. For example, when there is the repaired pixel, the repair control signal RCS may be generated as a first logic level voltage, and otherwise, the repair control signal RCS may be generated as a second logic level voltage. The coordinate data CD of the repaired pixel is a signal indicating a coordinate value of the repaired pixel. The coordinate data CD of the repaired pixel may be stored in a memory of the timing controller 50. The timing controller 50 outputs the repair control signal RCS, the coordinate data CD of the repaired pixel, and the digital video data DATA to the second data driver 40.

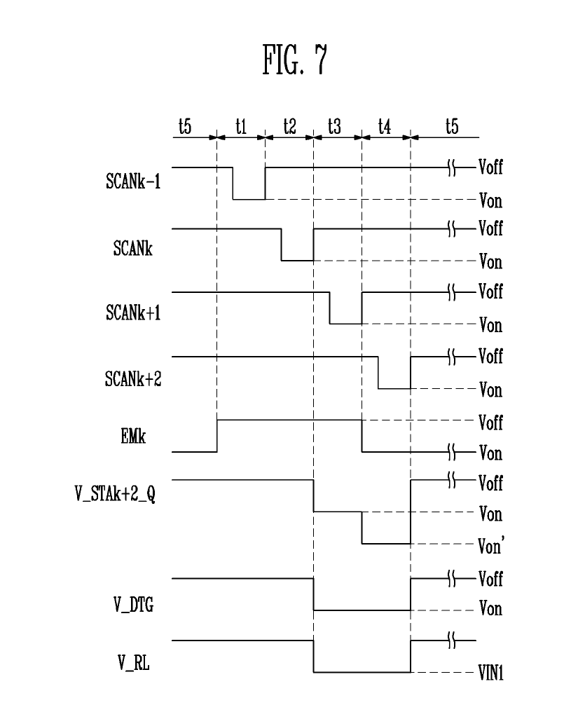

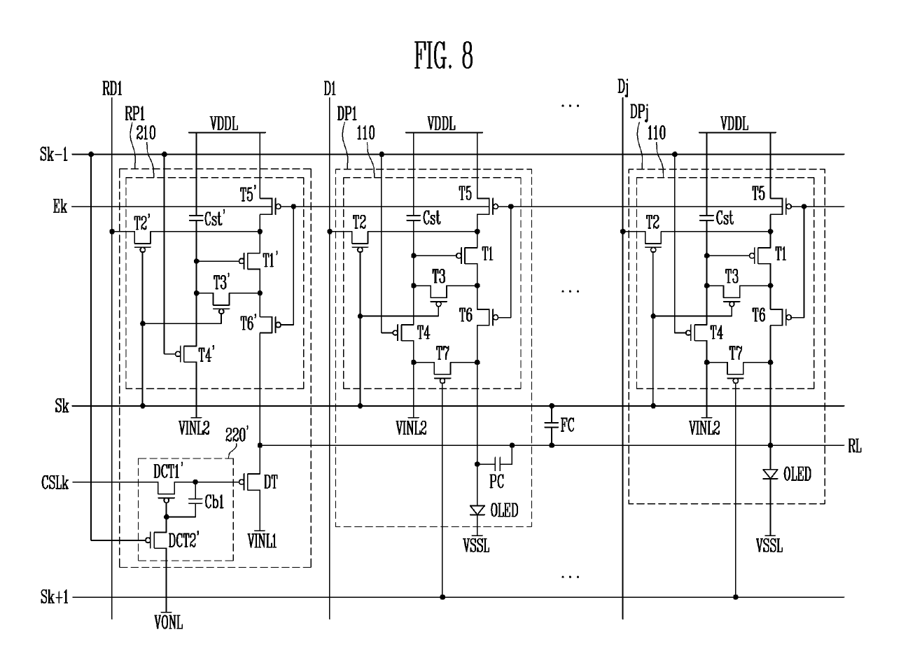

The organic light emitting display device according to the exemplary embodiment may further include a power supply source (not illustrated). The power supply source (not illustrated) may supply a plurality of power voltages to the plurality of power voltage lines. For example, the power supply source (not illustrated) may supply first to fourth power voltages to first to fourth power voltage lines. The plurality of power voltage lines and the plurality of power voltages will be described in detail with reference to FIG. 7. Further, the power supply (not illustrated) may supply a gate off voltage to a gate off voltage line and supply a gate on voltage to a gate on voltage line. The gate off voltage and the gate on voltage will be described in detail with reference to FIG. 8 below.

FIG. 2 is a block diagram illustrating the display pixels DPs, the auxiliary pixels RP, the auxiliary lines RLs, the auxiliary data lines RD1 and RD2, and the second data driver 40 of FIG. 1 in detail. For convenience of the description, FIG. 2 illustrates only the display pixels DPs, the auxiliary pixels RPs, the auxiliary lines RLs, the auxiliary data lines RD1 and RD2, and the second data driver 40.

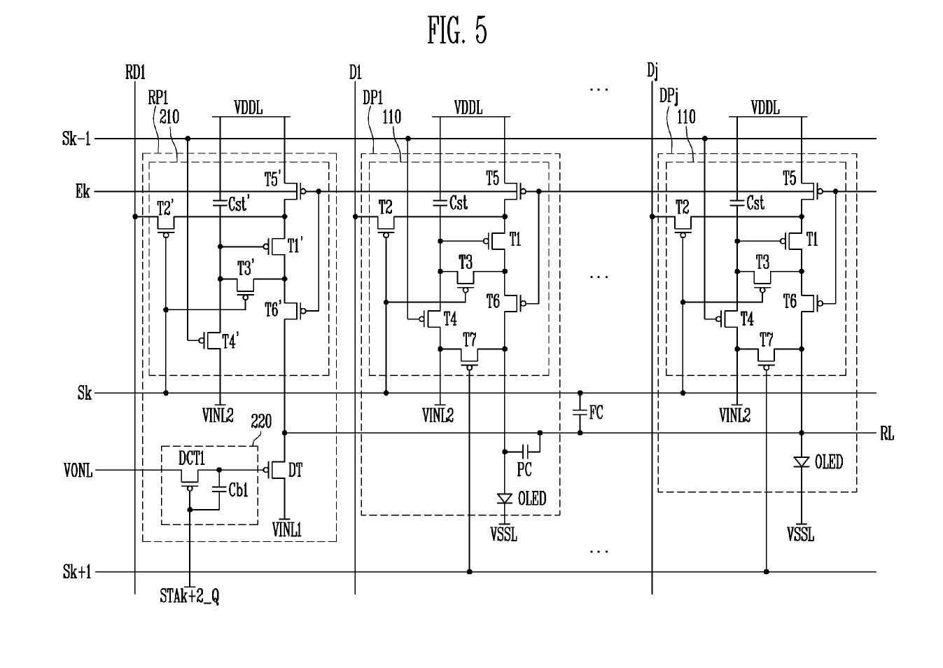

Referring to FIG. 2, each of the display pixels DPs includes a display pixel driver 110 and an organic light emitting diode OLED. The organic light emitting diode OLED emits light with brightness according to a driving current of the display pixel driver 110. An anode electrode of the organic light emitting diode OLED may be connected to the display pixel driver 110, and a cathode electrode may be connected to a fourth power voltage line VSSL to which a fourth power voltage is supplied. The fourth power voltage may be a low potential power voltage. The display pixel driver 110 will be described in detail with reference to FIG. 5 below.

Each of the auxiliary pixels RPs includes an auxiliary pixel driver 210 and a discharge transistor DT. The auxiliary pixel driver 210 and the discharge transistor DT are connected to the auxiliary line RL. The auxiliary pixel driver 210 supplies a driving current to the auxiliary line RL. The discharge transistor DT discharges the auxiliary line RL with the first power voltage. The discharge transistor DT may be connected to the auxiliary line RL and a first power voltage line VINL1 for supplying the first power voltage. A control electrode of the discharge transistor DT may be connected to various signals, which will be described with reference to FIGS. 5, 8, 10, 13, and 15.

The auxiliary line RL is connected to the auxiliary pixel RP, and extended to the display area DA from the auxiliary pixel RP crossing the display pixels DPs. For example, as illustrated in FIG. 2, the auxiliary line RL may be formed to be connected to the auxiliary pixel RP in a p^{th} row (p is a positive integer satisfying 1≦p≦n), and cross the display pixels DPs in the p^{th} row. Further, as illustrated in FIG. 2, the auxiliary line RL may be formed to cross the anode electrodes of the organic light emitting diodes OLEDs of the display pixels DPs.

The auxiliary line RL may be connected to any one of the display pixels DPs of the display area DA. In this case, the display pixel DP connected to the auxiliary line RL may correspond to a defective pixel which needs to be repaired. Referring to FIG. 2, the display pixel DP connected to the auxiliary line RL is defined as a repaired pixel RDP1/RDP2. Particularly, the auxiliary line RL may be connected to the anode electrode of the organic light emitting diode OLED of the repaired pixel RDP1/RDP2. In this case, the display pixel driver 110 and the organic light emitting diode OLED of the repaired pixel RDP1/RDP2 are disconnected.

The auxiliary pixels RPs of the first auxiliary pixel area RPA1 are connected to a first auxiliary data line RD1, and the auxiliary pixels RPs of the second auxiliary pixel area RPA2 are connected to the second auxiliary data line RD2. The display pixels DPs of the display area DA are connected to the data lines D1 to Dm, but the data lines D1 to Dm are omitted in FIG. 2 for convenience of the description.

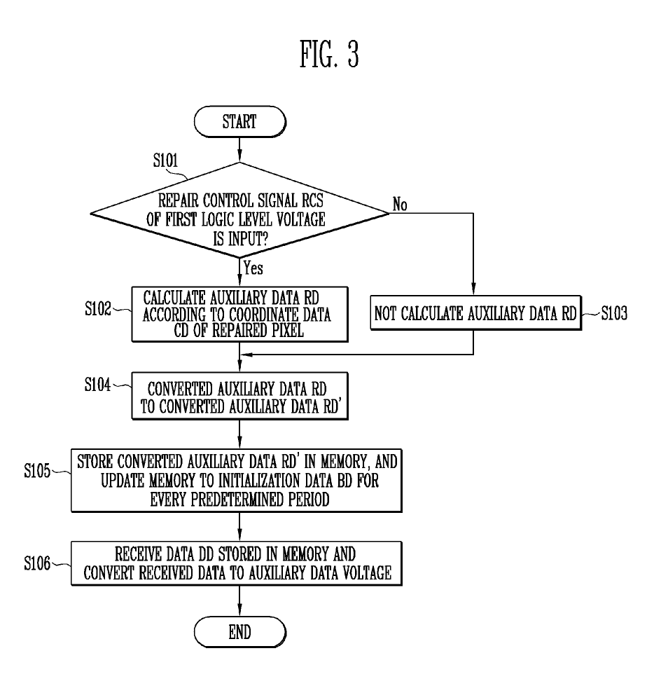

The second data driver 40 includes an auxiliary data calculating unit 41, an auxiliary data converter 42, a memory 43, and an auxiliary data voltage converter 44. A driving method of the second data driver 40 will be described with reference to FIGS. 2 and 3.

FIG. 3 is a flowchart illustrating a driving method of the second data driver of FIG. 2. Referring to FIG. 3, a driving method of the second data driver includes operations S101 to S106.

First, the auxiliary data calculator 41 receives the repair control signal RCS, the digital video data DATA, and the coordinate data CD of the repaired pixel RDP1/RDP2 from the timing controller 50. The auxiliary data calculating unit 41 is configured to calculate auxiliary data RD when the repair control signal RCS has the first logic level voltage, and configured not to calculate the auxiliary data RD when the repair control signal RCS has the second logic level voltage. That is, when the repair control signal RCS of the first logic level voltage is input, the auxiliary data calculating unit 41 is configured to calculate the auxiliary data RD from the digital video data DATA according to the coordinate data CD of the repaired pixel.

The auxiliary data calculating unit 41 may calculate the digital video data corresponding to a coordinate value of the repaired pixel RDP1/RDP2 as the auxiliary data RD. For example, when the first repaired pixel RDP1 is positioned in the second row and the second column as illustrated in FIG. 2, a coordinate value of the first repaired pixel RDP1 may be (2, 2). Referring to FIG. 2, the row and the column correspond only to the display area DA. Referring to FIG. 2, n display pixels DPs are disposed in the column direction (a y-axis direction), and the second repaired pixel RDP2 is positioned in the n−1^{th} row and the second column, and therefore, a coordinate value of the second repaired pixel RDP2 may be (2, n−1).

According to the FIG. 2, the auxiliary data calculating unit 41 may calculate digital video data corresponding to the coordinate value (2, 2) as the auxiliary data RD, which is to be supplied to the auxiliary pixel RP connected to the first repaired pixel RDP1, and digital video data corresponding to the coordinate value (2, n−1) as the auxiliary data RD, which is to be supplied to the auxiliary pixel RP connected to the second repaired pixel RDP2. The auxiliary data calculating unit 41 outputs the calculated auxiliary data RD to the auxiliary data converter 42. (S101, S102, and S103).

Second, the auxiliary data converter 42 receives the auxiliary data RD from the auxiliary data calculating unit 41. The repaired pixel RDP1/RDP2 receives the auxiliary data voltage from the auxiliary pixel RP through the auxiliary line RL. Accordingly, the auxiliary data converter 42 may convert the auxiliary data RD by adding predetermined data to the auxiliary data RD considering wire resistance of the auxiliary line RL and parasitic capacitance formed in the auxiliary line RL. The auxiliary data converter 42 outputs converted auxiliary data RD′ to the memory 43. (S104).

The auxiliary data converter 42 may be omitted. In this case, the auxiliary data calculating unit 41 may directly output the auxiliary data RD to the memory 43.

Third, the memory 43 receives and stores the converted auxiliary data RD′ from the auxiliary data converter 42. When the auxiliary data converter 42 is omitted, the memory 43 may receive and store the auxiliary data RD directly from the auxiliary data calculating unit 41.

The memory 43 may be set to be updated to have initialization data BD for every predetermined period. Particularly, the memory 43 may receive a signal indicating a predetermined period from the timing controller 50. The signal indicating a predetermined period may be a vertical sync signal (vsync) for generating a pulse for every one frame period, or a horizontal sync signal (hsync) for generating a pulse for every one horizontal frame period. The one frame period means a period for which the data voltages are supplied to all of the display pixels DPs, and the one horizontal period means a period for which the data voltages are supplied to the display pixels DPs of any one row. When the signal indicating a predetermined period is the vertical sync signal vsync, the memory 43 may be updated to have the initialization data BD for every one frame period. When the signal indicating a predetermined period is the horizontal sync signal hsync, the memory 43 may be updated to have the initialization data BD for every one horizontal period. The memory 43 may be implemented by a register. The memory 43 outputs data DD stored therein to the auxiliary data voltage converter 44 (S105).

Fourth, the auxiliary data voltage converter 44 receives the data DD stored in the memory 43 and converts the received data DD to the auxiliary data voltage. The auxiliary data voltage converter 44 synchronizes each of the auxiliary data voltages to one of the scan signals, respectively, and supplies the synchronized auxiliary data voltages to the auxiliary data lines RD1 and RD2. Accordingly, the auxiliary data voltages supplied to the auxiliary data lines RD1 and RD2 are synchronized with the data voltages supplied to the data lines D1 to Dm to be supplied. That is, the auxiliary data voltage supplied to the auxiliary pixel RP of the p^{th} row is synchronized to the data voltages supplied to the display pixels DPs of the p^{th} row to be supplied (S106).

As described above, in the exemplary embodiment of the present invention, the digital video data DATA corresponding to the coordinate value of the repaired pixel RDP1/RDP2 as the auxiliary data RD. As a result, in the exemplary embodiment of the present invention, the auxiliary data voltage to be supplied to the auxiliary pixel RP connected to the repaired pixel RDP1/RDP2 may be same to the data voltage to be supplied to the repaired pixel RDP1/RDP2.

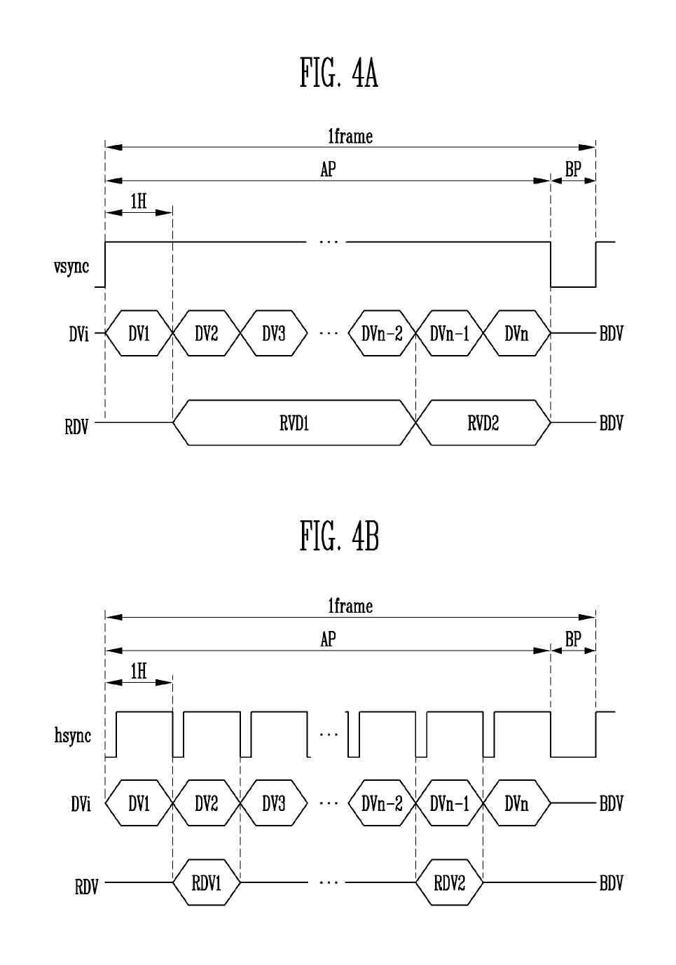

FIG. 4A is diagram illustrating an example of data voltages output from the first data driver, and auxiliary data voltages output from the auxiliary data voltage converter of the second data driver of FIG. 2. The exemplary data voltages output in FIG. 4A illustrates the vertical sync signal vsync, data voltages DVi output from the first data driver 30 to an i^{th} data line Di (i is a positive integer satisfying 1≦I≦m), and auxiliary data voltages RDV output from the auxiliary data voltage converter 44 to the auxiliary data lines RD1 and RD2.

Referring to FIG. 4A, one frame period (1 frame) includes an active period AP during which the data voltages are supplied to the display pixels DPs, and a blank period BP which is an idle period. The vertical sync signal vsync includes a pulse having a cycle of one frame period (1 frame). The data voltages DVi output to the i^{th} data line Di may include first to n^{th} n data voltages DV1 to DVn. As illustrated in FIG. 2, the auxiliary data voltage supplied to the auxiliary pixel RP in the p^{th} row may be synchronized to the data voltages supplied to the display pixels DPs in the p^{th} row.

Referring to FIG. 2, the first repaired pixel RDP1 may be positioned in the second row, and the second repaired pixel RDP2 may be positioned in the n−1^{th} row. In this case, the data DD may include a first data DD1 and a second data DD2, and the first auxiliary data voltage RDV1 may be supplied to the auxiliary data line RD1/RD2, synchronized to a period for which the data voltage DV2 is supplied to the i^{th} data line Di in the second row. Further, the second auxiliary data voltage RDV2 may be supplied to the auxiliary data line RD1/RD2, synchronized to a period for which a data voltage DVn−1 is supplied to the i^{th} data line Di in the n−1^{th} row.

When the signal indicating the predetermined period is the vertical sync signal vsync, the memory 43 may be updated to have the initialization data BD for every one frame period. Accordingly, the auxiliary data voltage converter 44 may receive the first data DD1 from the memory 43, from a period for which the data voltage DV2 is supplied to the display pixel in the second row, to a period for which the data voltage DVn−2 is supplied to the display pixel in the n−2^{th} row, and convert the input first data DD1 into the first auxiliary data voltage RDV1 and output the first auxiliary data voltage RDV1 to the auxiliary data line RD1/RD2.

The auxiliary data voltage converter 44 may receive the second data DD2 from the memory 43, from a period for which the data voltage DVn−1 is supplied to the display pixel in the n−1^{th} row, to a period for which the data voltage DVn is supplied to the display pixel in the n^{th} row, and convert the second auxiliary data RD2 into the second auxiliary data voltage RDV2 and output the second auxiliary data voltage RDV2 to the auxiliary data line RD1/RD2. Further, as illustrated in FIG. 4A, the auxiliary data voltage converter 44 may receive the initialization data BD from the memory 43 during the period for which the data voltage DV1 is supplied to the display pixel in the first row, and convert the input initialization data BD into initialization data voltage BDV and output the initialization data voltage BDV to the auxiliary data line RD1/RD2.

As a result, as illustrated in FIG. 4A, the auxiliary data voltages supplied to the auxiliary data lines RD1 and RD2 may be synchronized with the data voltages supplied to the data lines D1 to Dm.

FIG. 4B is diagram illustrating an example of data voltages output from the first data driver, and auxiliary data voltages output from the auxiliary data voltage converter of the second data driver of FIG. 2. The exemplary data voltages output in FIG. 4B illustrates the horizontal sync signal hsync, the data voltages DVi output from the first data driver 30 to the i^{th} data line, and the auxiliary data voltages RDV output from the auxiliary data voltage converter 44 to the auxiliary data lines RD1 and RD2.

Referring to FIG. 4B, one frame period (1 frame) includes an active period AP during which the data voltages are supplied, and a blank period BP which is an idle period. The horizontal sync signal hsync includes a pulse having a cycle of one horizontal period (1H). The data voltages DVi output to the i^{th} data line Di may include first to n^{th} data voltages DV1 to DVn. As illustrated in FIG. 2, the auxiliary data voltage supplied to the auxiliary pixel RP in the p^{th} row may be synchronized to the data voltages supplied to the display pixels DPs in the p^{th} row.

Referring to FIG. 2, the first repaired pixel RDP1 may be positioned in the second row, and the second repaired pixel RDP2 may be positioned in the n−1^{th} row. In this case, the data DD may include a first data DD1 and a second data DD2, and the first auxiliary data voltage RDV1 may be supplied to the auxiliary data line RD1/RD2, synchronized to a period for which the data voltage DV2 is supplied to the i^{th} data line Di in in the second row. Further, the second auxiliary data voltage RDV2 may be supplied to the auxiliary data line RD1/RD2, synchronized to a period for which a data voltage DVn−1 is supplied to the i^{th} data line Di in the n−1^{th} row.

When the signal indicating the predetermined period is the horizontal sync signal hsync, the memory 43 may be updated to have the initialization data BD for every one horizontal period (1H). Accordingly, as illustrated in FIG. 4B, the auxiliary data voltage converter 44 may receive the first data DD1 from the memory 43 only for a period, for which the data voltage DV2 is supplied to the display pixel in the second row, convert the input first data DD1 into the first auxiliary data voltage RDV1, and output the first auxiliary data voltage RDV1 to the auxiliary data line RD1/RD2.

The auxiliary data voltage converter 44 may receive the second data DD2 from the memory 43, only for a period for which the data voltage DVn−1 is supplied to the display pixel in the n−1^{th} row, convert the second data DD2 into the second auxiliary data voltage RDV2, and output the second auxiliary data voltage RDV2 to the auxiliary data line RD1/RD2. Further, as illustrated in FIG. 4B, the auxiliary data voltage converter 44 may receive the initialization data BD from the memory 43 for the remaining periods, except for the period, for which the data voltage DV2 is supplied to the display pixel in the second row, and the period, for which the data voltage DVn−1 is supplied to the display pixel in the n−1^{th} row, and convert the input initialization data BD into the initialization data voltage BDV, and output the initialization data voltage BDV to the auxiliary data line RD1/RD2.

As a result, as illustrated in FIG. 4B, the auxiliary data voltages supplied to the auxiliary data lines RD1 and RD2 are synchronized with the data voltages supplied to the data lines D1 to Dm.

Further, as described with reference to FIG. 4B, the initialization data voltage BDV may be supplied to the auxiliary pixels which are not connected to the repaired pixels RDP1 and RDP2. As a result, in the exemplary embodiment of the present invention, it is possible to prevent the display pixels DPs of the display area from being influenced by a change in a voltage of the auxiliary lines connected to the auxiliary pixels which are not connected to the repaired pixels RDP1 and RDP2. When the auxiliary pixel RP receives the auxiliary data voltage, it is possible to supply the driving current to the auxiliary line RL for the purpose of preventing the voltage of the auxiliary line RL from being changed.

FIG. 5 is a circuit diagram illustrating exemplary display pixels and auxiliary pixels of the display panel according to an exemplary embodiment in detail.

For convenience of the description, FIG. 5 illustrates only k−1^{th}, k^{th}, and k+1^{th} scan lines Sk−1, Sk, and Sk+1 (k is a positive integer satisfying 1≦k≦n), the first auxiliary data line RD1, first and j^{th} data lines D1 and Dj (j is a positive integer satisfying 2≦j≦m), and a k^{th} emission control line Ek. Further, for convenience of the description, FIG. 5 illustrates only the first auxiliary pixel RP1 connected to the first auxiliary data line RD1 and the k−1^{th}, k^{th}, and k+1^{th} scan lines Sk−1, Sk, and Sk+1, the first display pixel DP1 connected to the first data line D1 and the k−1^{th}, k^{th}, and k+1^{th} scan lines Sk−1, Sk, and Sk+1, and the j^{th} display pixel DPj connected to the j^{th} data line Dj and the k−1^{th}, k^{th}, and k+1^{th} scan lines Sk−1, Sk, and Sk+1. FIG. 5 illustrates that the first display pixel DP1 does not include a defect generated from the manufacturing process, and the j^{th} display pixel DPj is a repaired pixel, which is a defective pixel that had been repaired. Hereinafter, the first auxiliary pixel RP1, the first display pixel DP1, and the j^{th} display pixel DPj will be described in detail with reference to FIG. 5.

Referring to FIG. 5, the first auxiliary pixel RP1 is connected to the j^{th} display pixel DPj, which is connected to the repaired pixel through the auxiliary line RL. Particularly, the auxiliary line RL is extended to the display area DA from the first auxiliary pixel RP1 overlapping the display pixels DP1 and DPj. The auxiliary line RL may be electrically connected to the organic light emitting diode OLED of any one of the display pixels DP1 and DPj. In the exemplary embodiment illustrated in FIG. 5, the auxiliary line RL is electrically connected to the organic light emitting diode OLED of the j^{th} display pixel DPj, the repaired pixel.

Each of the display pixels DP1 and DPj includes the organic light emitting diode OLED and the display pixel driver 110. The display pixel driver 110 is connected to the organic light emitting diode OLED, and supplies the driving current to the organic light emitting diode OLED. The display pixel driver 110 may be connected to at least one scan line, at least one emission control line, and the plurality of power lines. For example, the display pixel driver 110 may be connected the k−1^{th}, k^{th}, and k+1^{th} scan lines Sk−1, Sk, and Sk+1, the k^{th} emission control line Ek, and the second and third power voltage lines VDDL and VINL2. Further, the display pixel driver 110 may include a plurality of transistors. For example, the display pixel driver 110 may include first to seventh transistors T1, T2, T3, T4, T5, T6, and T7, and a storage capacitor Cst.

The first transistor T1 controls a driving current I_{ds} between a drain and a source according to a voltage applied to a control electrode thereof. The current I_{ds} between the drain and the source flowing through a channel of the first transistor T1 is in proportion to a square of a difference between a voltage between a gate and the source of the first transistor T1 V_{gs} and a threshold voltage Vₜₕ, as expressed by Equation 1.

I_{ds}=k′·(V_{gs}−Vₜₕ)² Equation 1

In Equation 1, k′ means a proportional coefficient determined by a structure and a physical property of the first transistor T1, V_{gs} means a voltage between the control electrode and a first electrode of the first transistor T1, and Vₜₕ means a threshold voltage of the first transistor T1.

The second transistor T2 is connected to the first electrode of the first transistor T1 and the first data line D1. The second transistor T2 is turned on by a scan signal of the K^{th} scan line Sk to connect the first electrode of the first transistor T1 and the data line D1/Dj. Accordingly, the data voltage of the data line D1/Dj is supplied to the first electrode of the first transistor T1. A control electrode of the second transistor T2 is connected to the k^{th} scan line Sk, a first electrode of the second transistor T2 is connected to the data line D1/Dj, and a second electrode of the second transistor T2 is connected to the first electrode of the first transistor T1. Here, the control electrode may be a gate electrode, and the first electrode and the second electrode may respectively be one of a source electrode or a drain electrode. For example, when the first electrode is a source electrode, the second electrode may be a drain electrode.

The third transistor T3 is connected to the control electrode of the first transistor T1 and the second electrode of the first transistor T1. The third transistor T3 is turned on by the scan signal of the K^{th} scan line Sk to connect the control electrode and the second electrode of the first transistor T1. When the control electrode and the second electrode of the first transistor T1 are connected, the first transistor T1 may be driven as a diode. A control electrode of the third transistor T3 is connected to the k^{th} scan line Sk, a first electrode of the third transistor T3 is connected to the second electrode of the first transistor T1, and a second electrode of the third transistor T3 is connected to the control electrode of the first transistor T1.

The fourth transistor T4 is connected to the control electrode of the first transistor T1 and a third power voltage line VINL2 to which a third power voltage is supplied. The fourth transistor T4 is turned on by a scan signal of the K−1^{th} scan line Sk−1 to connect the control electrode of the first transistor T1 and the third power voltage line VINL2. Accordingly, the control electrode of the first transistor T1 may be initialized with the third power voltage. A control electrode of the fourth transistor T4 is connected to the k−1^{th} scan line Sk−1, a first electrode of the fourth transistor T4 is connected to the control electrode of the first transistor T1, and a second electrode of the fourth transistor T4 is connected to the third power voltage line VINL2.

The fifth transistor T5 is connected to the second power voltage line VDDL and the first electrode of the first transistor T1. The fifth transistor T5 is turned on by an emission control signal of the k^{th} emission control line Ek to connect the second power voltage line VDDL and the first electrode of the first transistor T1. Accordingly, a second power voltage is supplied to the first electrode of the first transistor T1. A control electrode of the fifth transistor T5 is connected to the k^{th} emission control line Ek, a first electrode of the fifth transistor T5 is connected to the second power voltage line VDDL, and a second electrode of the fifth transistor T5 is connected to the first electrode of the first transistor T1.

The sixth transistor T6 is connected to the second electrode of the first transistor T1 and the organic light emitting diode OLED. The sixth transistor T6 is turned on by the emission control signal of the k^{th} emission control line Ek to connect the second electrode of the first transistor T1 and the organic light emitting diode OLED. A control electrode of the sixth transistor T6 is connected to the k^{th} emission control line Ek, a first electrode of the sixth transistor T6 is connected to the second electrode of the first transistor T1, and a second electrode of the sixth transistor T6 is connected to the organic light emitting diode OLED.

Regarding the first display pixel DP1, when the fifth and sixth transistors T5 and T6 are turned on, the driving current I_{ds} between the drain and the source of the first transistor T1 is supplied to the organic light emitting diode OLED of the first display pixel DP1. Accordingly, the organic light emitting diode OLED of the first display pixel DP1 emits light.

The seventh transistor T7 is connected between the anode electrode of the organic light emitting diode OLED and the third power voltage line VINL2. The seventh transistor T7 is turned on by the scan signal of the K+1^{th} scan line Sk+1 to connect the anode electrode of the organic light emitting diode OLED and the third power voltage line VINL2. Accordingly, the anode electrode of the organic light emitting diode OLED is discharged with the third power voltage. A control electrode of the seventh transistor T7 is connected to the k+1^{th} scan line Sk+1, a first electrode of the seventh transistor T7 is connected to the anode electrode of the organic light emitting diode OLED, and a second electrode of the seventh transistor T7 is connected to the third power voltage line VINL2.

The organic light emitting diode OLED emits light according to the driving current I_{ds} from the first transistor T1 of the display pixel driver 110. The intensity of the emitted light from the organic light emitting diode OLED may be in proportion to the driving current I_{ds} from the first transistor T1. The anode electrode of the organic light emitting diode OLED is connected to the first electrode of the second transistor T1 and the second electrode of the seventh transistor T7, and a cathode electrode of the organic light emitting diode OLED is connected to the fourth power voltage line VSSL.

The storage capacitor Cst is connected to the control electrode of the first transistor T1 and the second power voltage line VDDL to maintain a voltage of the control electrode of the first transistor T1. One electrode of the storage capacitor Cst is connected to the control electrode of the first transistor T1, and the other electrode of the storage capacitor Cst is connected to the second power voltage line VDDL.

The first auxiliary pixel RP1 includes the auxiliary pixel driver 210, the discharge transistor DT, and a discharge transistor controller 220. The first auxiliary pixel RP1 does not include the organic light emitting diode OLED.

The auxiliary pixel driver 210 is connected to the organic light emitting diode OLED of the j^{th} display pixel DPj through the auxiliary line RL to supply the driving current I_{ds}′. The auxiliary pixel driver 210 may be connected to at least one scan line, one emission control line, and the plurality of power lines. For example, the auxiliary pixel driver 210 may be connected to the k−1^{th}, k^{th}, and k+1^{th} scan lines Sk−1, Sk, and Sk+1, the k^{th} emission control line Ek, and the second and first power voltage lines VDDL and VINL1. Further, the auxiliary pixel driver 210 may include a plurality of transistors. For example, the auxiliary pixel driver 210 may include first to sixth transistors T1′, T2′, T3′, T4′, T5′, and T6′.

The first, third, fourth, and fifth transistors T1′, T3′, T4′, and T5′ and a storage capacitor Cst′ of the auxiliary pixel driver 210 may be substantially and identically formed to the first, third, fourth, and fifth transistors T1, T3, T4, and T5 and the storage capacitor Cst of the display pixel driver 110. Accordingly, detailed descriptions of the first, third, fourth, and fifth transistors T1′, T3′, T4′, and T5′ and the storage capacitor Cst′ of the auxiliary pixel driver 210 will be omitted.

The second transistor T2′ is connected to a first electrode of the first transistor T1′ and the first auxiliary data line RD1. The second transistor T2′ is turned on by the scan signal of the K^{th} scan line Sk to connect to a first electrode of the first transistor T1′ and the first auxiliary data line RD1. Accordingly, the data voltage of the first auxiliary data line RD1 is supplied to the first electrode of the first transistor T1′. A control electrode of the second T2′ is connected to the k^{th} scan line Sk, a first electrode of the second transistor T2′ is connected to the first auxiliary data line RD1, and a second electrode of the second transistor T2′ is connected to the first electrode of the first transistor T1′.

The sixth transistor T6′ is connected to a second electrode of the first transistor T1′ and the auxiliary line RL. The sixth transistor T6′ is turned on by the emission control signal of the K^{th} emission control line Ek to connect the second electrode of the first transistor T1′ and the auxiliary line RL. A control electrode of the sixth transistor T6′ is connected to the k^{th} emission control line Ek, a first electrode of the sixth transistor T6′ is connected to the second electrode of the first transistor T1′, and a second electrode of the sixth transistor T6′ is connected to the auxiliary line RL. When the fourth and fifth transistors T4′ and T5′ are turned on, a current Ids′ between a drain and a source of the first transistor T1′ is supplied to the organic light emitting diode OLED of the j^{th} display pixel DPj through the auxiliary line RL, so that the organic light emitting diode OLED of the j^{th} display pixel DPj emits light.

The discharge transistor DT is connected to the auxiliary line RL and the first power voltage line VINL1 to which the first power voltage is supplied. The discharge transistor DT is turned on by the voltage supplied to the control electrode of the discharge transistor DT from the discharge transistor controller 220 to connect the auxiliary line RL and the first power voltage line VINL1 to which the first power voltage is supplied. Accordingly, the voltage of the auxiliary line RL may be discharged with the first power voltage, and the discharge transistor DT may discharge the auxiliary line RL. The control electrode of the discharge transistor DT may be connected to the discharge transistor controller 220, a first electrode of the discharge transistor DT may be connected to the auxiliary line RL, and a second electrode of the discharge transistor DT may be connected to the first power voltage line VINL1.

The discharge transistor controller 220 controls turn-on and turn-off of the discharge transistor DT. The discharge transistor controller 220 may include at least one active element. Here, the active element may be any one of a diode, a transistor, and a switch. The discharge transistor controller 220 may include a first discharge control transistor DCT1 and a first boosting capacitor Cb1 as illustrated in FIG. 5.

The first discharge control transistor DCT1 may be connected to the control electrode of the discharge transistor DT and a gate on voltage line VONL. The gate on voltage capable of turning on the discharge transistor Dt may be supplied to the gate on voltage line VONL. The first discharge control transistor DCT1 is turned on by the voltage supplied to the control electrode of the first discharge control transistor DCT1 to connect the control electrode of the discharge transistor DT and the gate on voltage line VONL. Accordingly, the discharge transistor DT is turned on.

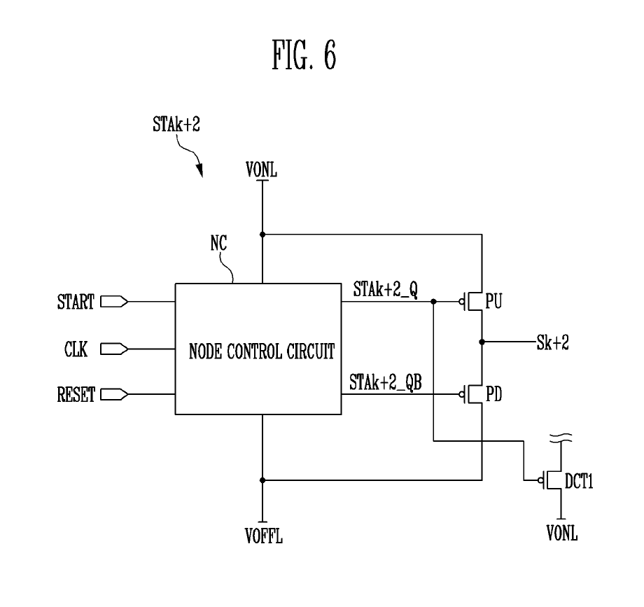

The control electrode of the first discharge control transistor DCT1 may be connected to a pull-up control node of a scan stage connected to any one scan line. For example, the control electrode of the first discharge control transistor DCT1 may be connected to a pull-up control node (STAk+2_Q) of a scan stage connected to a k+2^{th} scan line. The pull-up control node of the scan stage connected to the k+2^{th} scan line will be described with reference to FIG. 6 below. Further, a first electrode of the first discharge control transistor DCT1 may be connected to the control electrode of the discharge transistor DT, and a second electrode of the first discharge control transistor DCT1 may be the gate on voltage line VONL.

The first boosting capacitor Cb1 is connected to the control electrode of the first discharge control transistor DCT1 and the control electrode of the discharge transistor DT. That is, one electrode of the first boosting capacitor Cb1 is connected to the control electrode of the first discharge control transistor DCT1, and the other electrode may be connected to the control electrode of the discharge transistor DT.

Referring to FIGS. 1, 2, and 5, each of the display pixel driver 110 in the display pixels DP1 to DPm, except for the j^{th} display pixel corresponding to the repaired pixel, is connected to the organic light emitting diode OLED and supplies the driving current I_{ds} to the organic light emitting diode OLED. However, the display pixel driver 110 of the j^{th} display pixel DPj is not connected with the organic light emitting diode OLED. That is, since the display pixel driver 110 of the j^{th} display pixel DPj cannot properly perform its function due to the inherent defect, the display pixel driver 110 and the organic light emitting diode OLED are disconnected, and the anode electrode of the organic light emitting diode OLED of the j^{th} display pixel DPj is connected to the auxiliary line RL through a laser short-circuit process. Accordingly, the anode electrode of the organic light emitting diode OLED of the j^{th} display pixel DPj may be connected to the auxiliary pixel driver 210 of the first auxiliary pixel RP1 through the auxiliary line RL. Thus, the organic light emitting diode OLED of the j^{th} display pixel DPj receives the driving current I_{ds}′ from the auxiliary pixel driver 210 of the first auxiliary pixel RP1 to emit light. As a result, the j^{th} display pixel DPj may be repaired.

For convenience of the description, FIG. 5 illustrates only the exemplary embodiment of the first auxiliary pixel RP1, the first display pixel DP1 which is normal, and the j^{th} display pixel DPj, a repaired pixel. However, each of the auxiliary pixels RP1 to RPn may be implemented substantially identical to the first auxiliary pixel RP1, each of the normal display pixels may be implemented substantially identical to the first display pixel DP1. And each of the repaired pixels may be implemented substantially identical to the j^{th} display pixel DPj.

The auxiliary line RL may overlap the anode electrodes of the organic light emitting diodes OLEDs of the display pixels, so a parasitic capacitance PC may be formed between the auxiliary line RL and the anode electrodes of OLEDs of the display pixels as illustrated in FIG. 5. Further, the auxiliary line RL is formed in parallel to the k^{th} scan line Sk while being adjacent to the k^{th} scan line, so a fringe capacitance FC may be formed between the auxiliary line RL and the k^{th} scan line. A voltage of the auxiliary line RL may be affected by the parasitic capacitance PC and the fringe capacitance FC, and thus the i^{th} display pixel DPj, the repaired pixel, may emit light erroneously.

In order to solve the problem, in the exemplary embodiment of the present invention, the auxiliary line RL is discharged with the first power voltage by using the discharge transistor DT. As a result, in the exemplary embodiment of the present invention, it is possible to prevent the voltage of the auxiliary line RL from being affected from the parasitic capacitance PC and the fringe capacitance FC. Accordingly, in the exemplary embodiment of the present invention, it is possible to prevent or limit the organic light emitting diode OLED from erroneously emitting light. This will be described in detail with reference to FIG. 7 below.

FIG. 6 is a circuit diagram illustrating an example of a k+2^{th} stage of the scan driver for outputting the k+2^{th} scan signal of FIG. 5. Referring to FIG. 6, a k+2th scan stage STAk+2 for outputting the k+2^{th} scan signal to a k+2^{th} scan line Sk+2 includes a pull-up control node STAk+2_Q, a pull-down control node STAk+2_QB, a pull-up transistor PU, a pull-down transistor PD, a node control circuit NC, and a second boosting capacitor Cb2 (not shown).

The pull-up transistor PU outputs a clock signal input through a clock terminal CLK to the k+2^{th} scan line Sk+2 according to a voltage of the pull-up control node STAk+2_Q. The clock signal may be any one of a plurality of clock signals. A control electrode of the pull-up transistor PU is connected to the pull-up control node STAk+2_Q, a first electrode of the pull-up transistor PU is connected to the k+2^{th} scan line Sk+2, and a second electrode of the pull-up transistor PU is connected to the clock terminal CLK.

The pull-down transistor PD outputs a gate off voltage of a gate off voltage line VOFFL to the k+2^{th} scan line Sk+2 according to a voltage of the pull-down control node STAk+2_QB. A control electrode of the pull-down transistor PD is connected to the pull-down control node STAk+2_QB, the first electrode of the pull-down transistor PD is connected to the gate off voltage line VOFFL, and the second electrode of the pull-down transistor PD is connected to the k+2^{th} scan line Sk+2.

The node control circuit NC controls a voltage of the pull-up control node STAk+2_Q and a voltage of the pull-down control node STAk+2_QB. The node control circuit NC includes a plurality of signal input terminals. For example, the node control circuit NC may include a start terminal START into which a start signal is input, and a reset terminal RESET into which a reset signal is input. Further, the node control circuit NC may be connected to the gate on voltage line VONL and the gate off voltage line VOFFL. The start signal may be a gate start signal or a carry signal of a preceding scan stage. The reset signal may be a carry signal of a subsequent scan stage. The gate on voltage line VONL may supply a gate on voltage, and the gate off voltage line VOFFL may supply a gate off voltage. The gate on voltage is a turn-on voltage of each of the transistors included in the scan stages, the display pixels, and the auxiliary pixels, and the gate off voltage is a turn-off voltage of each of the transistors included in the scan stages, the display pixels, and the auxiliary pixels.

In the description below, the preceding scan stage refers to a stage positioned at an upper side of a reference scan stage. For example, the preceding scan stage of the k+2^{th} scan stage STAk+2 may indicate any one of the first to k+1^{th} scan stages STAT to STAk+1. The subsequent scan stage refers to a stage positioned at a lower side of the reference scan stage. For example, the rear end scan stage of the k+2^{th} scan stage STAk+2 may indicate any one of the k+3^{th} to n+1^{th} scan stages STAk+3 to STAn+1.

The node control circuit NC supplies the gate on voltage to the pull-up control node STAk+2_Q in response to the start signal input to the start terminal START, and supplies the gate off voltage to the pull-down control node STAk+2_QB. Accordingly, when the clock signal is input through the clock terminal CLK, the pull-up control node STAk+2_Q is bootstrapped by the second boosting capacitor Cb2 (not shown), so the pull-up transistor PU may be fully turned on. As a result, the clock signal input through the clock terminal CLK is output to the k+2^{th} scan line Sk+2 as the k+2^{th} scan signal.

The node control circuit NC supplies the gate off voltage to the pull-up control node STAk+2_Q in response to the reset signal input to the reset terminal RESET, and supplies the gate on voltage to the pull-down control node STAk+2_QB. Accordingly, the pull-down transistor PD is turned on, so the gate off voltage of the gate off voltage line VOFFL is output to the k+2^{th} scan line SK+2 as the k+2^{th} scan signal.

FIG. 6 illustrates an example of the case where the node control circuit NC includes only the start terminal START and the reset terminal RESET, but the present invention is not limited thereto. That is, the node control circuit NC may include additional terminals, other than the two terminals.

Referring to FIG. 6, the pull-up control node STAk+2_Q of the k+2^{th} scan stage STAk+2 may be connected to the control electrode of the first discharge control transistor DCT1 of the discharge transistor controller 220. However, the exemplary embodiment of the present invention is not limited thereto, and the control electrode of the first discharge control transistor DCT1 may be connected to a pull-down control node STAk+2_QB of a scan stage connected to any one scan line.

For convenience of the description, FIG. 6 illustrates only the k+2^{th} scan stage STAk+2. However, the scan stages connected to the scan lines S0 to Sn+1, respectively, may be implemented substantially identical to the k+2^{th} scan stage STAk+2. Further, the emission stages connected to the emission control lines E1 to En, respectively, may be similarly implemented to the k+2th scan stage STAk+2.

FIG. 7 is a waveform illustrating signals supplied to the display pixels and the auxiliary pixels of FIG. 5. FIG. 7 illustrates a k−1^{th} scan signal SCANk−1 supplied to a k−1^{th} scan line Sk−1, a k^{th} scan signal SCANk supplied to a k^{th} scan line Sk, a k+1^{th} scan signal SCANk+1 supplied to a k+1^{th} scan line Sk+1, a k+2^{th} scan signal SCANk+2 supplied to a k+2^{th} scan line Sk+2, a k^{th} emission control signal EMk supplied to the k^{th} emission control line Ek, a voltage V_STAk+2_Q of the pull-up control node STAk+2_Q of the k+2^{th} scan stage STAk+2, a voltage V_DTG supplied to the control electrode of the discharge transistor DT, and a voltage V_RL of the auxiliary line RL.

Referring to FIG. 7, the one frame period may be divided into first to fifth periods t1 to t5. The k−1^{th} scan signal SCANk−1 is generated as the gate on voltage Von during the first period t1, the k^{th} scan signal SCANk is generated as the gate on voltage Von during the second period t2, the k+1^{th} scan signal SCANk+1 is generated as the gate on voltage Von during the third period t3, and the k+2^{th} scan signal SCANk+2 is generated as the gate on voltage Von during the fourth period t4. That is, the scan signals are sequentially generated as the gate on voltage Von. The k^{th} emission signal EMk is generated as the gate off voltage Voff during the first to third periods t1 to t3.

Hereinafter, a driving method of the first auxiliary pixel RP1 and the j^{th} display pixel DPj, and a driving method of the first display pixel DP1 will be described in detail with reference to FIGS. 5 and 7.

A driving method of the first display pixel DP1 will be described in detail.

First, the k−1^{th} scan signal SCANk−1 of the gate on voltage Von is supplied to the k−1^{th} scan line Sk−1 during the first period t1. Accordingly, the fourth transistor T4 is turned on during the first period t1. Since the fourth transistor T4 is turned on, the control electrode of the first transistor T1 is initialized with the third power voltage of the third power voltage line VINL2.

Second, the k^{th} scan signal SCANk of the gate on voltage Von is supplied to the k^{th} scan line Sk during the second period t2. Accordingly, the second and third transistors T2 and T3 are turned on during the second period t2.

Since the second transistor T2 is turned on, the data voltage Vdata of the first data line D1 is supplied to the first electrode of the first transistor T1. Since the third transistor T3 is turned on, the control electrode and the second electrode of the first transistor T1 are connected, so that the first transistor T1 is driven as a diode.

The first transistor T1 is formed in a P-type, so when a voltage difference Vgs (VIN2−Vdata) between the control electrode and the first electrode of the first transistor T1 is smaller than a threshold voltage Vₜₕ of the first transistor T1 (V_{gs}<Vₜₕ), the first transistor T1 is turned on. Since the voltage difference V_{gs} (VIN2−Vdata) between the control electrode and the first electrode of the first transistor T1 is smaller than the threshold voltage Vₜₕ, a current flows in the first transistor T1 until the voltage difference V_{gs} between the control electrode and the first electrode of the first transistor T1 reaches the threshold voltage Vₜₕ of the first transistor T1. Accordingly, the voltage of the control electrode of the first transistor T1 is increased to Vdata+Vₜₕ during the second period t2.

Third, the k+1^{th} scan signal SCANk+1 of the gate on voltage Von is supplied to the k+1^{th} scan line Sk+1 during the third period t3. Accordingly, the seventh transistor T7 is turned on during the third period t3. Since the seventh transistor T7 is turned on, the anode electrode of the organic light emitting diode OLED is connected to the third power voltage line VINL2. Accordingly, the anode electrode of the organic light emitting diode OLED is initialized with the third power voltage. The third power voltage may be a voltage between a fourth power voltage VSS supplied to the fourth power voltage line VSSL and a voltage (VSS+OLEDVTH) obtained by adding the fourth power voltage VSS to a threshold voltage OLEDVTH of the organic light emitting diode OLED. Further, the third power voltage may be different from the first power voltage supplied to the first power voltage line VINL1. For example, the first power voltage may be a voltage (VSS+a) obtained by adding the fourth power voltage VSS to a predetermined voltage a.

Fourth, the k^{th} emission control signal EMk of the gate on voltage Von is supplied to the k^{th} emission control line Ek during the fourth period t4. Accordingly, the fifth and sixth transistors T5 and T6 are turned on during the fourth period t4. Since the fifth and sixth transistors T5 and T6 are turned on, the current I_{ds} between the drain and the source flows through the first transistor T1 according to the voltage of the control electrode. In this case, the control electrode of the first transistor T1 maintains “Vdata+Vₜₕ” by the storage capacitor Cst. The driving current I_{ds} between the drain and the source of the first transistor T1 may be defined as Equation 2.

I_{ds}=k′·(V_{gs}−Vₜₕ)²=k′·((Vdata+Vth)−VDD−Vth)² Equation 2

In Equation 2, k′ means a proportional coefficient determined by a structure and a physical property of the first transistor T1, V_{gs} means a voltage between the gate and the source of the first transistor T1, Vₜₕ means the threshold voltage of the first transistor T1, VDD means the second power voltage, and Vdata means the data voltage. Here, the voltage of the control electrode of the first transistor T1 is Vdata+Vₜₕ, and a source voltage Vs is VDD. When Equation 2 is organized, Equation 3 is deducted.

I_{ds}=k′·(Vdata−VDD)² Equation 3

Finally, the current I_{ds} between the drain and the source of the first transistor T1 is not dependent on the threshold voltage Vₜₕ of the first transistor T1 as expressed by Equation 3. That is, the threshold voltage Vₜₕ of the first transistor T1 is compensated. The current I_{ds} between the drain and the source of the first transistor T1 is supplied to the organic light emitting diode OLED. Accordingly, the organic light emitting diode OLED emits light.

Fifth, the k^{th} emission control signal EMk of the gate on voltage Von is supplied to the k^{th} emission control line Ek during the fifth period t5. Accordingly, since the fifth and sixth transistors T5 and T6 are turned on during the fifth period t5, the organic light emitting diode OLED emits light similar to the fourth period t4.

Next, a driving method of the first auxiliary pixel RP1 and the j^{th} display pixel DPj will be described in detail.

First, the k−1^{th} scan signal SCANk−1 of the gate on voltage Von is supplied to the k−1^{th} scan line Sk−1 during the first period t1. Accordingly, the fourth transistor T4′ is turned on during the first period t1. Since the fourth transistor T4′ is turned on, the control electrode of the first transistor T1′ is initialized with the third power voltage of the third power voltage line VINL2.

Second, the k^{th} scan signal SCANk of the gate on voltage Von is supplied to the k^{th} scan line Sk during the second period t2. Accordingly, the second and third transistors T2′ and T3′ are turned on during the second period t2.

Since the second transistor T2′ is turned on, auxiliary data voltage Vrdata of the first auxiliary data line RD1 is supplied to the first electrode of the first transistor T1′. Since the third transistor T3′ is turned on, the control electrode and the second electrode of the first transistor T1′ are connected, so that the first transistor T1′ is driven as a diode.

Since a voltage difference V_{gs} (VIN2−Vdata) between the control electrode and the first electrode of the first transistor T1′ is smaller than the threshold voltage Vₜₕ, a current flows in the first transistor T1′ until the voltage difference V_{gs} between the control electrode and the first electrode of the first transistor T1′ reaches the threshold voltage Vₜₕ of the first transistor T1′. Accordingly, the voltage of the control electrode of the first transistor T1′ is increased to Vdata+Vₜₕ during the second period t2.

Third, the k+1^{th} scan signal SCANk+1 of the gate on voltage Von is supplied to the k+1^{th} scan line Sk+1 during the third period t3. Further, the pull-up control node STAk+2_Q of the k+2^{th} scan stage STAk+2 connected to the k+2^{th} scan line Sk+2 has the gate on voltage Von during the third period t3. Accordingly, the first discharge control transistor DCT1 is turned on during the third period t3.

Since the first discharge control transistor DCT1 is turned on, the gate on voltage Von is supplied to the control electrode of the discharge transistor DT as illustrated in FIG. 7. As a result, the discharge transistor DT is turned on, the voltage V_RL of the auxiliary line RL is initialized with the first power voltage VIN1.

Fourth, the k^{th} emission control signal EMk of the gate on voltage Von is supplied to the k^{th} emission control line Ek during the fourth period t4. Accordingly, the fifth and sixth transistors T5′ and T6′ are turned on during the fourth period t4. Since the fifth and sixth transistors T5′ and T6′ are turned on, the current I_{ds} between the drain and the source flows from the first transistor T1′ according to the voltage of the control electrode. In this case, the control electrode of the first transistor T1′ maintains “Vdata+Vth” by the storage capacitor Cst. In this case, the current I_{ds} between the drain and the source of the first transistor T1′ may be defined as Equation 2. Similar to the proffered discussion, Equation 2 may be organized and deducted to Equation 3.

Finally, the current I_{ds} between the drain and the source of the first transistor T1′ is not dependent on the threshold voltage Vₜₕ of the first transistor T1′ as expressed by Equation 3. That is, the threshold voltage Vₜₕ of the first transistor T1′ is compensated.

Further, the pull-up control node STAk+2_Q of the k+2^{th} scan stage STAk+2 connected to the k+2^{th} scan line Sk+2 has a voltage Von′ lower than the gate on voltage Von during the fourth period t4 by bootstrapping of the second boosting capacitor Cb2 (not shown). Accordingly, the first discharge control transistor DCT1 is turned on during the fourth period t4.

Since the first discharge control transistor DCT1 is turned on, the gate on voltage Von is supplied to the control electrode of the discharge transistor DT as illustrated in FIG. 7. As a result, the discharge transistor DT is turned on, the voltage V_RL of the auxiliary line RL is initialized with the first power voltage VIN1.

When the auxiliary line RL is connected to the first power voltage line VINL1 during the fourth period t4, the current I_{ds} between the drain and the source of the first transistor T1′ is not supplied to the organic light emitting diode OLED of the j^{th} display pixel DPj through the auxiliary line RL, but is discharged to the first power voltage line VINL1. Accordingly, the organic light emitting diode OLED of the j^{th} display pixel DPj does not emit light during the fourth period t4.

Fifth, the k^{th} emission control signal EMk of the gate on voltage Von is supplied to the k^{th} emission control line Ek during the fifth period t5. Accordingly, the fifth and sixth transistors T5′ and T6′ are turned on during the fifth period t5.

Further, the pull-up control node STAk+2_Q of the k+2^{th} scan stage STAk+2 connected to the k+2^{th} scan line Sk+2 has the gate off voltage Voff during the fifth period t5. Accordingly, the first discharge control transistor DCT1 is turned on during the fifth period t5. Further, a variation of the voltage of the pull-up control node STAk+2_Q of the k+2^{th} scan stage STAk+2 is reflected to the control electrode of the discharge transistor DT of the first auxiliary pixel RP1 during the fifth period t5, so that the voltage of the control electrode of the discharge transistor DT has the gate off voltage Voff. Accordingly, the discharge transistor DT is turned off.

As a result, the current I_{ds} between the drain and the source of the first transistor T1 of the first auxiliary pixel RP1 is supplied to the organic light emitting diode OLED of the j^{th} display pixel DPj through the auxiliary line RL. Accordingly, the organic light emitting diode OLED of the j^{th} display pixel DPj emits light.

The parasitic capacitance PC may be formed between the auxiliary line RL and the anode electrodes of the organic light emitting diodes OLEDs of the display pixels as illustrated in FIG. 5. Accordingly, the voltage of the auxiliary line RL may be increased by the parasitic capacitance PC during the fourth period t4 for which the driving current of the display pixel driver 110 is supplied, and the voltage of the anode electrodes of the organic light emitting diodes OLEDs of the display pixels are varied. However, in the exemplary embodiment of the present invention, the auxiliary line RL is connected to the first power voltage line VINL1 during the third and fourth periods t3 and t4, so the auxiliary line RL is discharged with the first power voltage during the third and fourth periods t3 and t4. Accordingly, in the exemplary embodiment of the present invention, it is possible to prevent or limit the voltage of the auxiliary line RL from being affected due to the parasitic capacitance PC, thereby preventing or limiting the organic light emitting diode OLED of the j^{th} display pixel DPj from erroneously emitting light due to the parasitic capacitance PC.

Further, the fringe capacitance FC may be formed between the auxiliary line RL and the k^{th} scan line Sk as illustrated in FIG. 5. The voltage of the auxiliary line RL may be increased by the fringe capacitance FC during the third period t3 for which the voltage of the scan signal of the k^{th} scan line Sk is varied. However, in the exemplary embodiment of the present invention, the auxiliary line RL is connected to the first power voltage line VINL1 during the third and fourth periods t3 and t4, so the auxiliary line RL is discharged with the first power voltage during the third and fourth periods t3 and t4. Accordingly, in the exemplary embodiment of the present invention, it is possible to prevent or limit the voltage of the auxiliary line RL from being affected due to the fringe capacitance FC, thereby preventing or limiting the organic light emitting diode OLED of the j^{th} display pixel DPj from erroneously emitting light due to the fringe capacitance FC.

FIG. 8 is a circuit diagram illustrating display pixels and auxiliary pixels of a display panel according to an exemplary embodiment in detail.

For convenience of the description, FIG. 8 illustrates only the k−1^{th}, k^{th}, k+1^{th} scan lines Sk−1, Sk, and Sk+1, the first auxiliary data line RD1, and the first and j^{th} data lines D1 and Dj, and the k^{th} emission control line Ek. Further, for convenience of the description, FIG. 8 illustrates only the auxiliary pixel RP1 connected to the first auxiliary data line RD1 and the k−1^{th}, k^{th}, and k+1^{th} scan lines Sk−1, Sk, and Sk+1, the first display pixel DP1 connected to the first data line D1 and the k−1^{th}, k^{th}, and k+1^{th} scan lines Sk−1, Sk, and Sk+1, and the j^{th} display pixel DPj connected to the j^{th} data line Dj and the k−1^{th}, k^{th}, and k+1^{th} scan lines Sk−1, Sk, and Sk+1. FIG. 8 illustrates that a first display pixel DP1 does not include a defect generated from the manufacturing process, and a j^{th} display pixel DPj is a repaired pixel, which is a defective pixel that had been repaired. Hereinafter, a first auxiliary pixel RP1, the first display pixel DP1, and the j^{th} display pixel DPj will be described in detail with reference to FIG. 8.

Referring to FIG. 8, the first auxiliary pixel RP1 is connected to the j^{th} display pixel DPj, which is connected to the repaired pixel, through an auxiliary line RL. Particularly, the auxiliary line RL is extended to a display area DA from the first auxiliary pixel RP1. The auxiliary line RL may be electrically connected to an organic light emitting diode OLED of the j^{th} display pixel DPj.

Each of the display pixels DP1 and DPj includes an organic light emitting diode OLED and a display pixel driver 110. The display pixels DP1 and DPj illustrated in FIG. 8 are substantially the same as the display pixels DP1 and DPj illustrated in FIG. 5. Accordingly, detailed descriptions of the display pixels DP1 and DPj illustrated in FIG. 8 will be omitted.

The first auxiliary pixel RP1 includes an auxiliary pixel driver 210, a discharge transistor DT, and a discharge transistor controller 220′. The first auxiliary pixel RP1 does not include the organic light emitting diode OLED.

The auxiliary pixel driver 210 and the discharge transistor DT of the first auxiliary pixel RP1 illustrated in FIG. 8 are substantially the same as the auxiliary pixel driver 210 and the discharge transistor DT of the first auxiliary pixel RP1 illustrated in FIG. 5. Accordingly, detailed descriptions of the auxiliary pixel driver 210 and the discharge transistor DT of the first auxiliary pixel RP1 illustrated in FIG. 8 will be omitted.

The discharge transistor controller 220′ controls turn-on and turn-off of the discharge transistor DT. The discharge transistor controller 220′ may include at least one active element. Here, the active element may be any one of a diode, a transistor, and a switch. For example, the discharge transistor controller 220 may include first and second discharge control transistors DCT1′ and DCT2′ and a first boosting capacitor Cb1 as illustrated in FIG. 8.

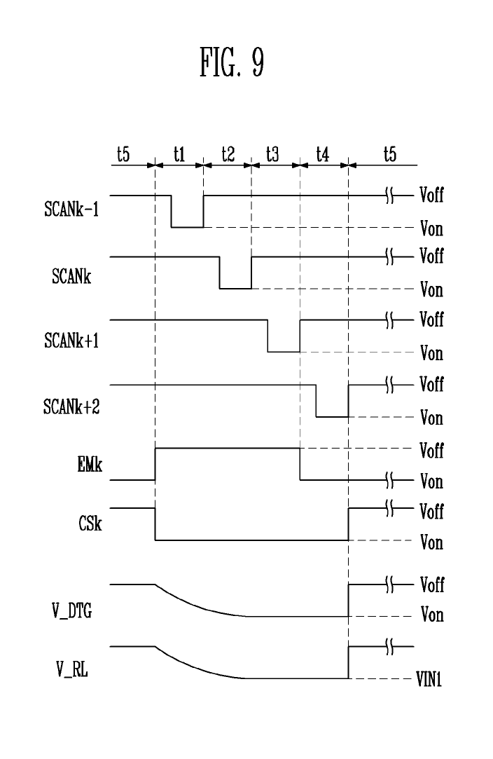

Particularly, the first discharge control transistor DCT1′ may be connected to a control electrode of the discharge transistor DT and a k^{th} control signal line CSLk. A k^{th} control signal CSk may be supplied to the k^{th} control signal line CSLk as illustrated in FIG. 9. The first discharge control transistor DCT1′ is turned on by the voltage supplied to the control electrode of the first discharge control transistor DCT1′ to connect the control electrode of the discharge transistor DT and the k^{th} control signal line CSLk. The control electrode of the first discharge control transistor DCT1′ may be connected to the first electrode of the second discharge control transistor DCT2′, a first electrode of the first discharge control transistor DCT1′ may be connected to the k^{th} control signal line CSLk, and a second electrode of the first discharge control transistor DCT1′ may be connected to the control electrode of the discharge transistor DT.

The second discharge control transistor DCT2′ may be connected to the control electrode of the first discharge control transistor DCT1′ and a gate on voltage line VONL to which the gate on voltage is supplied. The second discharge control transistor DCT2′ is turned on by the voltage supplied to the control electrode of the second discharge control transistor DCT2′ to connect the control electrode of the first discharge control transistor DCT1′ and the gate on voltage line VONL. Accordingly, the first discharge control transistor DCT1′ is turned on. The control electrode of the second discharge control transistor DCT2′ may be connected to any one scan line. For example, the second discharge control transistor DCT2′ may be connected to the k−1^{th} scan line Sk−1 or the k^{th} scan line Sk. The control electrode of the second discharge control transistor DCT2′ may be connected to any one scan line, a first electrode of the second discharge control transistor DCT2′ may be connected to the control electrode of the first discharge control transistor DCT1′, and a second electrode of the second discharge control transistor DCT2′ may be connected to the gate on voltage line VONL.

The first boosting capacitor Cb1 is connected to the control electrode of the first discharge control transistor DCT1′ and the control electrode of the discharge transistor DT. That is, one electrode of the first boosting capacitor Cb1 is connected to the control electrode of the first discharge control transistor DCT1′ and the other electrode may be connected to the control electrode of the discharge transistor DT.

The display pixel driver 110 in the display pixels DP1 to DPn except for the j^{th} display pixel corresponding to the repaired pixel, is connected to the organic light emitting diode OLED, and supplies the driving current I_{ds} to the organic light emitting diode OLED. However, the display pixel driver 110 of the j^{th} display pixel DPj is not connected with the organic light emitting diode OLED. That is, since the display pixel driver 110 of the j^{th} display pixel DPj cannot properly perform its function due to the inherent defect, the display pixel driver 110 and the organic light emitting diode OLED are disconnected, and the anode electrode of the organic light emitting diode OLED of the j^{th} display pixel DPj is connected to the auxiliary line RL through a laser short-circuit process. Accordingly, the anode electrode of the organic light emitting diode OLED of the j^{th} display pixel DPj may be connected to the auxiliary pixel driver 210 of the first auxiliary pixel RP1 through the auxiliary line RL. Accordingly, the organic light emitting diode OLED of the j^{th} display pixel DPj receives the driving current I_{ds} from the auxiliary pixel driver 210 of the first auxiliary pixel RP1 to emit light. Accordingly, the j^{th} display pixel DPj is repaired.

For convenience of the description, FIG. 8 illustrates only the exemplary embodiment of the first auxiliary pixel RP1, the first display pixel DP1 which does not include the defect, and the j^{th} display pixel DPj which is a repaired pixel. However, each of the auxiliary pixels RP1 to RPn may be implemented substantially identical to the first auxiliary pixel RP1, each of the display pixels which does not include the defect may be implemented substantially identical to the first display pixel DP1, and each of the repaired pixels may be implemented substantially identical to the j^{th} display pixel DPj.

The auxiliary line RL may overlap the anode electrodes of the organic light emitting diodes OLEDs of the display pixels, so the parasitic capacitances PCs may be formed between the auxiliary line RL and the anode electrodes of the organic light emitting diodes OLEDs of the display pixels as illustrated in FIG. 8. Further, the auxiliary line RL may be formed in parallel to the k^{th} scan line Sk while being adjacent to the k^{th} scan line, so fringe capacitance FC may be formed between the auxiliary line RL and the k^{th} scan line. A voltage of the auxiliary line RL may be affected by the parasitic capacitance PC and the fringe capacitance FC. Thus, the organic light emitting diode OLED of the j^{th} display pixel DPj corresponding to the repaired pixel may erroneously emit light.

In order to solve the problem, in the exemplary embodiment of the present invention, the auxiliary line RL is discharged with the first power voltage by using the discharge transistor DT and the discharge transistor controller 220. As a result, in the exemplary embodiment of the present invention, it is possible to prevent the voltage of the auxiliary line RL from being affected by the parasitic capacitance PC and the fringe capacitance FC. Accordingly, in the exemplary embodiment of the present invention, it is possible to prevent or limit the organic light emitting diode OLED from erroneously emitting light.

FIG. 9 is a waveform illustrating signals supplied to the display pixels and the auxiliary pixels of FIG. 8. FIG. 9 illustrates a k−1^{th} scan signal SCANk−1 supplied to a k−1^{th} scan line Sk−1, a k^{th} scan signal SCANk supplied to a k^{th} scan line Sk, a k+1^{th} scan signal SCANk+1 supplied to a k+1^{th} scan line Sk+1, a k+2^{th} scan signal SCANk+2 supplied to a k+2^{th} scan line Sk+2, a k^{th} emission control signal EMk supplied to the k^{th} emission control line Ek, a k^{th} control signal CSk supplied to a kth control signal line CSLk, a voltage V_DTG supplied to the control electrode of the discharge transistor DT, and a voltage V_RL of the auxiliary line RL.

Referring to FIG. 9, the one frame period may be divided into first to fifth period t1 to t5. The k−1^{th} scan signal SCANk−1 is generated as the gate on voltage Von during the first period t1, the k^{th} scan signal SCANk is generated as the gate on voltage Von during the second period t2, the k+1^{th} scan signal SCANk+1 is generated as the gate on voltage Von during the third period t3, and the k+2^{th} scan signal SCANk+2 is generated as the gate on voltage Von during the fourth period t4. That is, the scan signals are sequentially generated as the gate on voltage Von. The k^{th} emission signal EMk is generated as the gate off voltage Voff during the first to third periods t1 to t3. The k^{th} control signal CSk is generated as the gate on voltage Von during the first to fourth periods t1 to t4. That is, a pulse of the k^{th} control signal CSk overlaps a pulse of the k^{th} emission signal EMk, and a width of the pulse of the k^{th} control signal CSk may be generated greater than a width of the pulse of the k^{th} emission signal EMk.

Hereinafter, a driving method of the first auxiliary pixel RP1 and the j^{th} display pixel DPj, and a driving method of the first display pixel DP1 will be described in detail with reference to FIGS. 8 and 9. A driving method of the first display pixel DP1 related to FIGS. 8 and 9 are substantially the same as the driving method of the first display pixel DP1 described with reference to FIGS. 5 and 7. Accordingly, the driving method of the first display pixel DP1 related to FIGS. 8 and 9 will be omitted. A driving method of the first auxiliary pixel RP1 and the j^{th} display pixel DPj will be described in detail.

First, the k−1^{th} scan signal SCANk−1 of the gate on voltage Von is supplied to the k−1^{th} scan line Sk−1 during the first period t1. Accordingly, the fourth transistor T4′ and the second discharge control transistor DCT2′ are turned on during the first period t1.

Since the fourth transistor T4′ is turned on, the control electrode of the first transistor T1′ is initialized with the third power voltage of the third power voltage line VINL2.

Since the second discharge control transistor DCT2′ is turned on, the control electrode of the first discharge control transistor DCT1′ is connected to the gate on voltage line VONL. Further, the k^{th} control signal CSk of the gate on voltage Von is supplied to the k^{th} control signal line CSLk during the first period t1. Accordingly, the first discharge control transistor DCT1′ is slightly turned on. Since the first discharge control transistor DCT1′ is slightly turned no, the voltage V_DTG supplied to the control electrode of the discharge transistor DT is gradually decreased to the gate on voltage Von. Accordingly, the discharge transistor DT is also slightly turned on. Accordingly, the voltage V_RL of the auxiliary line RL is also gradually discharged with the first power voltage VIN1.

In the meantime, the amount of variation of the voltage V_DTG supplied to the control electrode of the discharge transistor DT is reflected to the first discharge control transistor DCT1′ by the first boosting capacitor Cb1, so that the first discharge control transistor DCT1′ may be fully turned on according to a passage of time. Accordingly, the voltage V_DTG supplied to the control electrode of the discharge transistor DT is decreased to the gate on voltage Von, so that the discharge transistor DT is also fully turned on. Accordingly, the voltage V_RL of the auxiliary line RL is also gradually discharged with the first power voltage VIN1.

Second, the k^{th} scan signal SCANk of the gate on voltage Von is supplied to the k^{th} scan line Sk during the second period t2. Accordingly, the second and third transistors T2′ and T3′ are turned on during the second period t2.

Since the second transistor T2′ is turned on, the auxiliary data voltage Vrdata of the first auxiliary data line RD1 is supplied to the first electrode of the first transistor T1′. Since the third transistor T3′ is turned on, the control electrode and the second electrode of the first transistor T1′ are connected, so that the first transistor T1′ is driven as a diode.

Since a voltage difference V_{gs} (VIN2−Vrdata) between the control electrode and the first electrode of the first transistor T1′ is smaller than the threshold voltage Vₜₕ, a current flows in the first transistor T1′ until the voltage difference V_{gs} between the control electrode and the first electrode of the first transistor T1′ reaches the threshold voltage Vₜₕ of the first transistor T1′. Accordingly, the voltage of the control electrode of the first transistor T1′ is increased to Vrdata+Vₜₕ during the second period t2.

Third, the k+1^{th} scan signal SCANk+1 of the gate on voltage Von is supplied to the k+1^{th} scan line Sk+1 during the third period t3.

Fourth, the k^{th} emission control signal EMk of the gate on voltage Von is supplied to the k^{th} emission control line Ek during the fourth period t4. Accordingly, the fifth and sixth transistors T5′ and T6′ are turned on during the fourth period t4. Since the fifth and sixth transistors T5′ and T6′ are turned on, the current I_{ds} between the drain and the source flows from the first transistor T1′ according to the voltage of the control electrode. In this case, the control electrode of the first transistor T1′ maintains “Vrdata+Vₜₕ” by the storage capacitor Cst′. In this case, the current I_{ds} between the drain and the source of the first transistor T1′ may be defined as Equation 2. Equation 2 may be organized and deducted to Equation 3.

Finally, the current I_{ds} between the drain and the source of the first transistor T1′ is not dependent on the threshold voltage Vₜₕ of the first transistor T1′ as expressed by Equation 3. That is, the threshold voltage Vₜₕ of the first transistor T1′ is compensated.

When the auxiliary line RL is connected to the first power voltage line VINL1 during the fourth period t4, the current I_{ds} between the drain and the source of the first transistor T1′ is not supplied to the organic light emitting diode OLED of the j^{th} display pixel DPj through the auxiliary line RL, but is discharged to the first power voltage line VINL1. Accordingly, the organic light emitting diode OLED of the j^{th} display pixel DPj does not emit light during the fourth period t4.

Fifth, the k^{th} emission control signal EMk of the gate on voltage Von is supplied to the k^{th} emission control line Ek during the fifth period t5. Accordingly, the fifth and sixth transistors T5′ and T6′ remain turned on during the fifth period t5.

Further, the k^{th} control signal CSk supplied to the k^{th} control signal line CSLk has the gate off voltage Voff during the fifth period t5. Accordingly, the gate off voltage Voff is supplied to the control electrode of the discharge transistor DT during the fifth period t5. Accordingly, the discharge transistor DT is turned off. Further, the amount of variation of the voltage of the control electrode of the discharge transistor DT is reflected to the control electrode of the first discharge control transistor DCT1′ by the first boosting capacitor Cb1. Accordingly, the first discharge control transistor DCT1′ is turned off.

The current I_{ds} between the drain and the source of the first transistor T1′ is supplied to the organic light emitting diode OLED of the j^{th} display pixel DPj through the auxiliary line RL. Accordingly, the organic light emitting diode OLED of the j^{th} display pixel DPj emits light.

The parasitic capacitance PC may be formed between the auxiliary line RL and the anode electrodes of the organic light emitting diodes OLEDs of the display pixels as illustrated in FIG. 8. Accordingly, the voltage of the auxiliary line RL may be increased by the parasitic capacitance PC during the fourth period t4 for which the driving current of the display pixel driver 110 is supplied, and the voltage of the anode electrodes of the organic light emitting diodes OLEDs of the display pixels are varied. However, in the exemplary embodiment of the present invention, the auxiliary line RL is connected to the first power voltage line VINL1 during the first to fourth periods t1 to t4, so the auxiliary line RL is discharged with the first power voltage during the first to fourth periods t1 to t4. Accordingly, in the exemplary embodiment of the present invention, it is possible to prevent or limit the voltage of the auxiliary line RL from being affected due to the parasitic capacitance PC, thereby preventing or limiting the organic light emitting diode OLED of the j^{th} display pixel DPj from erroneously emitting light due to parasitic capacitance PC.

Further, the fringe capacitance FC may be formed between the auxiliary line RL and the k^{th} scan line Sk as illustrated in FIG. 8. The voltage of the auxiliary line RL may be increased by the fringe capacitance FC during the third period t3 for which the voltage of the scan signal of the k^{th} scan line Sk is varied. However, in the exemplary embodiment of the present invention, the auxiliary line RL is connected to the first power voltage line VINL1 during the first to fourth periods t1 to t4, so the auxiliary line RL is discharged with the first power voltage during the first to fourth periods t1 to t4. Accordingly, in the exemplary embodiment of the present invention, it is possible to prevent or limit the voltage of the auxiliary line RL from being affected due to the fringe capacitance FC, thereby preventing or limiting the organic light emitting diode OLED of the j^{th} display pixel DPj from erroneously emitting light due to the fringe capacitance FC.

In summary, according to the exemplary embodiments, the auxiliary line is discharged with the first power voltage by using the discharge transistor. As a result, it is possible to prevent or limit a voltage of the auxiliary line from being affected by parasitic capacitance between the auxiliary line and the anode electrodes of the organic light emitting diodes of the display pixels, and fringe capacitance between the auxiliary line and the scan line adjacent to the auxiliary line. Accordingly, in the exemplary embodiments, it is possible to prevent or limit the organic light emitting diode from erroneously emitting light.

Further, the digital video data corresponding to a coordinate value of a repaired pixel is calculated as auxiliary data. As a result, it is possible to supply the auxiliary data voltage to the auxiliary pixel and in turn, supply the data voltage to the repaired pixel, in order to run the repaired pixel.

According to the exemplary embodiments, initialization data, such as black data, is supplied to auxiliary pixels which are not involved in the repair. As a result, it is possible to prevent display pixels of a display area from being influenced by a change in voltages of the auxiliary lines connected to the auxiliary pixels which is not connected to the repaired pixel.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. An organic light emitting display device, comprising:
a data line and an auxiliary data line;
a scan line disposed crossing the data line and the auxiliary data line;
a display pixel disposed where the data line and the scan line cross;
an auxiliary pixel disposed where the auxiliary data line and the scan line cross; and
an auxiliary line connected to the auxiliary pixel,
wherein the auxiliary pixel comprises:
a discharge transistor coupled to the auxiliary line and a first power voltage line to which a first power voltage is supplied; and
a discharge transistor controller configured to switch the discharge transistor.

2. The organic light emitting display device of claim 1, wherein the discharge transistor controller comprises an active element.

3. The organic light emitting display device of claim 2, wherein the discharge transistor controller comprises:
a first discharge control transistor coupled to a control electrode of the discharge transistor and a gate on voltage line to which a gate on voltage is supplied; and
a first boosting capacitor coupled to the control electrode of the discharge transistor and a control electrode of the first discharge control transistor.

4. The organic light emitting display device of claim 3, wherein the control electrode of the first discharge control transistor is connected to a pull-up control node of a scan stage configured to output a scan signal to the scan line.

5. The organic light emitting display device of claim 2, wherein the discharge transistor controller comprises:
a first discharge control transistor coupled to a control electrode of the discharge transistor and a control signal line to which a control signal is supplied;
a second discharge control transistor coupled to a control electrode of the first discharge control transistor and a gate on voltage line to which a gate on voltage is supplied; and
a first boosting capacitor coupled to the control electrode of the discharge transistor and the control electrode of the first discharge control transistor.

6. The organic light emitting display device of claim 5, wherein the control electrode of the second discharge control transistor is connected to the scan line.

7. The organic light emitting display device of claim 1, wherein the auxiliary line is connected to the auxiliary pixel and the display pixel.

8. The organic light emitting display device of claim 1, wherein the display pixel comprises:
an organic light emitting diode; and
a display pixel driving circuit comprising a plurality of transistors, wherein the display pixel is configured to supply a driving current to the organic light emitting diode.

9. The organic light emitting display device of claim 8, wherein the display pixel driving circuit comprises:
a first transistor configured to control the driving current according to a voltage of a control electrode;
a second transistor coupled to the data line and a first electrode of the first transistor;
a third transistor coupled to the control electrode of the first transistor and a second electrode of the first transistor;
a fourth transistor coupled to the control electrode of the first transistor and a third power voltage line to which a third power voltage is supplied;
a fifth transistor coupled to the first electrode of the first transistor and a second power voltage line to which a second power voltage is supplied;
a sixth transistor coupled to the second electrode of the first transistor and an anode electrode of the organic light emitting diode;
a seventh transistor coupled to the anode electrode of the organic light emitting diode and the third power voltage line; and
a storage capacitor coupled to the control electrode of the first transistor and the second power voltage line.

10. The organic light emitting display device of claim 9, further comprising:
an emission control line disposed parallel to the scan line.

11. The organic light emitting display device of claim 10, wherein
a first scan line is coupled to a control electrode of the fourth transistor,
a second scan line is coupled to each control electrode of the second transistor and the third transistor,
a third scan line is coupled to a control electrode of the seventh transistor, and
the emission control line is coupled to each control electrode of the fifth transistor and the sixth transistors.

12. The organic light emitting display device of claim 1, wherein the auxiliary pixels further comprises:
an auxiliary pixel driving circuit comprising a plurality of transistors,
wherein the auxiliary pixel driving circuit is configured to supply a driving current to an organic light emitting diode of the display pixels.

13. The organic light emitting display device of claim 12, wherein the auxiliary pixel driving circuit further comprises:
a first transistor configured to control the driving current according to a voltage of a control electrode;
a second transistor coupled to the auxiliary data line and a first electrode of the first transistor;
a third transistor coupled to the control electrode of the first transistor and a second electrode of the first transistor;
a fourth transistor coupled to the control electrode of the first transistor and a third power voltage line to which a third power voltage is supplied;
a fifth transistor coupled to the first electrode of the first transistor and a second power voltage line to which a second power voltage is supplied;
a sixth transistor coupled to the second electrode of the first transistor and an anode electrode of the organic light emitting diode via the auxiliary line; and
a storage capacitor connected to the control electrode of the first transistor and the second power voltage line.

14. The organic light emitting display device of claim 13, further comprising:
an emission control line disposed parallel to the scan line.

15. The organic light emitting display device of claim 14, wherein
a first scan line is coupled to a control electrode of the fourth transistor,
a second scan line is coupled to each control electrode of the second transistor and the third transistor, and
the emission control line is coupled to each control electrode of the fifth transistor and the sixth transistors.

16. The organic light emitting display device of claim 1, wherein the auxiliary data line is formed at an outer side of the data lines.

17. The organic light emitting display device of claim 1, further comprising:
a scan driver configured to supply scan signals to the scan line;
a first data driver configured to supply data voltages to the data line; and
a second data driver configured to supply auxiliary data voltages to the auxiliary data line.

18. The organic light emitting display device of claim 17, wherein the second data driver comprises:
an auxiliary data calculating unit configured to calculate an auxiliary data from digital video data corresponding to a coordinate value of a repaired pixel among the display pixels;
a memory configured to store the auxiliary data and initialization data; and
an auxiliary data voltage converter configured to convert the auxiliary data and the initialization data into an auxiliary data voltage, and output the auxiliary data voltage to the auxiliary data line.

19. A method of driving a flat panel display, comprising:
determining existence of a repaired pixel;
preparing auxiliary data to feed the repaired pixel when the repaired pixel exists;
storing the auxiliary data;
generating a signal based on the auxiliary data; and
feeding the signal to the repaired pixel.

20. The method of claim 19, further comprising:
discharging a path that feeds the signal to the repaired pixel right before feeding the signal to the repaired pixel.
